(19) United States
(12) Patent Application Publication
(10) Pub. No.: US 2022/0172032 A1
(43) Pub. Date: Jun. 2, 2022

(54) NEURAL NETWORK CIRCUIT

(71) Applicant: NEC Corporation, Minato-ku, Tokyo (JP)

(72) Inventors: Seiya SHIBATA, Tokyo (JP); Yuka HAYASHI, Tokyo (JP)

(73) Assignee: NEC Corporation, Minato-ku, Tokyo (JP)

(21) Appl. No.: 17/437,947

(22) PCT Filed: Mar. 25, 2019
(86) PCT No.: PCT/JP2019/012581

§ 371 Date: Sep. 10, 2021

(51) Int. Cl. G06N 3/063

(52) U.S. Cl. CPC G06N 3/063

(57) ABSTRACT

A neural network circuit 201 is a neural network circuit divides convolution operation into convolution operation in a spatial direction and convolution operation in a channel direction, performs the respective convolution operation separately, and includes a 1×1 convolution operation circuit 10 that performs convolution in the channel direction, an SRAM 20 in which a computation result of the 1×1 convolution operation circuit 10 is stored, and an N×N convolution operation circuit 30 that performs convolution in the spatial direction for the computation result stored in the SRAM 20.

### TECHNICAL FIELD

The present invention relates to a neural network circuit associated with a convolutional neural network.

### BACKGROUND ART

A convolutional neural network (CNN) is used in various fields including image recognition. When using the CNN, a calculation amount becomes huge. As a result, the processing speed is reduced.

In general, in a convolution layer, since convolution operation in a spatial direction and convolution operation in a channel direction are performed simultaneously, a calculation amount becomes huge. Therefore, a method that separates the convolution operation in the spatial direction and the convolution operation in the channel direction and executes them separately is devised (see, for example, the non-patent literature 1).

In the convolution operation method described in the non-patent literature 1 (hereafter, referred to as a depthwise separable convolution), the convolution is separated into pointwise convolution, which is a 1×1 convolution, and a depthwise convolution. The pointwise convolution does not perform convolution in the spatial direction but convolution in the channel direction. The size of the depthwise convolution filter is, for example, 3×3.

FIGS. 8A-8C are explanatory diagrams showing the convolution filter used in the convolution operation. FIG. 8A relates to a normal (general) convolution filter. FIG. 8B relates to the depthwise convolution filter used in the depthwise separable convolution. FIG. 8C relates the pointwise convolution filter used in the depthwise separable convolution.

In the case of using a general convolution filter, when the vertical size of the input feature map is H, the horizontal size of the input feature map is W, the number of input channels is M, the filter size is K×K, and the number of output channels is N, the amount of multiplication (calculation amount) is H·W·M·K·K·N.

FIG. 8A shows the case where the filter size is D_{K}×D_{K}. In this case, a calculation amount is

$$H \cdot W \cdot M \cdot {D}_{K} \cdot {D}_{K} \cdot N . \qquad ( 1 )$$

Since the depthwise convolution in the depthwise separable convolution does not perform convolution in the channel direction (refer to the leftmost solid in FIG. 8B), a calculation amount is

$$H \cdot W \cdot {D}_{K} \cdot {D}_{K} \cdot M . \qquad ( 2 )$$

Since the pointwise convolution in the depthwise separable convolution does not perform convolution in the spatial direction, DK=1, as shown in FIG. 8C. Therefore, a calculation amount is

$$H \cdot W \cdot M \cdot M . \qquad ( 3 )$$

Comparing the sum of the calculation amount using equation (2) and the calculation amount using equation (3) (a calculation amount of the depthwise separable convolution) with the calculation amount using equation (1) a calculation amount of general convolution), the calculation amount of the depthwise separable convolution is [(1/N)+(1/D_{K}²)] times compared to the calculation amount of general convolution. When the size of the depthwise convolution filter is 3×3, the calculation amount for the depthwise separable convolution is reduced to about 1/9 compared to the calculation amount for general convolution, since the value of N is generally much larger than 3.

### CITATION LIST Non-Patent Literature

NPL 1: A. G Howard et al, “MobileNets: Efficient Convolutional Neural Networks for Mobile Vision Applications”, Google Inc., April 2017.

### SUMMARY OF INVENTION

### Technical Problem

In the following, it is supposed that a 3×3 filter is used in the depthwise convolution in the depthwise separable convolution. In this case, as shown in Table 1 of the non-patent literature 1, 1×1 matrix operation (1×1 convolution operation) and 3×3 matrix operation (3×3 convolution operation) are performed many times alternately.

When realizing an operation circuit that performs the depthwise separable convolution, the configuration shown in FIG. 9 can be considered as an example. The operation circuit shown in FIG. 9 includes a 1×1 convolution operation circuit 10 that performs a pointwise convolution, a 3×3 convolution operation circuit 30 that performs the depthwise convolution, a DRAM (Dynamic Random Access Memory) 50, and a weight memory 60.

The 3×3 convolution operation circuit 30 reads feature map data from the DRAM 50 and performs the depthwise convolution using a weight coefficient read from the weight memory 60. The 3×3 convolution operation circuit 30 writes a computation result to the DRAM 50. The 1×1 convolution operation circuit 10 reads data from the DRAM 50 and performs the pointwise convolution using a weight coefficient read from the weight memory 60. The 1×1 convolution operation circuit 10 reads the data from the DRAM 50 and performs the pointwise convolution using a weight coefficient read from the weight memory 60. The 1×1 convolution operation circuit 10 writes a computation result to the DRAM 50. The amount of calculation results output from the 1×1 convolution operation circuit 10 and the 3×3 convolution operation circuit 30 and the amount of data input to the 1×1 convolution operation circuit 10 and the 3×3 convolution operation circuit 30 are huge. Accordingly, the DRAM 50, which is relatively inexpensive even with its large capacity, is generally used as a memory to store data.

Before the 1×1 convolution operation circuit 10 starts a computation process, the weight coefficients for the 1×1 convolution operation are loaded into the weight memory 60. The weight coefficients for the 3×3 convolution operation are loaded into the weight memory 60 before the 3×3 convolution operation circuit 30 starts a computation process.

As mentioned above, a DRAM is a relatively inexpensive and high-capacity device. However, a DRAM is a low-speed memory device. In other words, the memory bandwidth of DRAM is narrow. Therefore, the data transfer between the operation circuit and the memory becomes a bottleneck. As a result, computation speed is limited. In particular, when the time required to read data required for one convolution operation from DRAM exceeds the time required for one convolution operation, this is called a memory bottleneck.

In order to improve the processing speed, it is conceivable to use a calculator using a Systolic Array as a calculator that performs matrix operation in the convolution layer. Alternatively, a SIMD (Single Instruction Multiple Data) type calculator may be used as a calculator that performs the sum-of-products operation.

For example, as illustrated in FIG. 10, it is conceivable to construct a 1×1 and 3×3 bi-functional circuit 70 that can perform the pointwise convolution and the depthwise convolution alternately in time. A high-speed operation circuit can be constructed by realizing the 1×1 and 3×3 bi-functional circuit 70 with a systolic array or a SIMD type calculator.

However, the configuration illustrated in FIG. 10 can not eliminate the bottleneck regarding data transfer between the operation circuit and the memory, because data is transferred between the 1×1 and 3×3 bi-functional circuit 70 and the DRAM 50. Additionally, it is possible to apply a calculator using a systolic array or a SIMD type calculator to the 1×1 convolution operation circuit 10 and the 3×3 convolution operation circuit 30 shown in FIG. 9. Even in that case, the bottleneck regarding data transfer between the operation circuit and the memory is not eliminated. Actually, as the processing efficiency of the calculator increases and the operation time is reduced, the tendency for the data transfer time to be larger than the operation time increases, and bottlenecks related to data transfer are more likely to occur.

It is an object of the present invention to provide a neural network circuit that can alleviate limitation of computation speed caused by data transfer to and from a narrowband memory.

### Solution to Problem

A neural network circuit according to the present invention divides convolution operation into convolution operation in a spatial direction and convolution operation in a channel direction, performs the respective convolution operation separately, and includes a 1×1 convolution operation circuit that performs convolution in the channel direction, an SRAM in which a computation result of the 1×1 convolution operation circuit is stored and an N×N convolution operation circuit that performs convolution in the spatial direction for the computation result stored in the SRAM.

### Advantageous Effects of Invention

According to this invention, it alleviates limitation on computing speed caused by data transfer to and from a narrowband memory.

### BRIEF DESCRIPTION OF DRAWINGS

FIG. 1 It depicts a block diagram showing an exemplary configuration of a neural network circuit of the first example embodiment.

FIG. 2 It depicts a block diagram showing an exemplary configuration of a neural network circuit of the second example embodiment.

FIG. 3 It depicts a block diagram showing an exemplary configuration of a neural network circuit of the third example embodiment.

FIG. 4 It depicts a block diagram showing an exemplary configuration of a neural network circuit of the fourth example embodiment.

FIG. 5 It depicts a block diagram showing a main part of a neural network circuit.

FIG. 6 It depicts a block diagram showing a main part of another neural network circuit.

FIG. 7 It depicts a block diagram showing a main part of still another neural network circuit.

FIG. 8A It depicts an explanatory diagram showing a convolution filter used in convolution operation.

FIG. 8B It depicts an explanatory diagram showing a convolution filter used in convolution operation.

FIG. 8C It depicts an explanatory diagram showing a convolution filter used in convolution operation.

FIG. 9 It depicts a block diagram showing an example of an operation circuit that performs a depthwise separable convolution.

FIG. 10 It depicts a block diagram showing another example of an operation circuit that performs a depthwise separable convolution.

### DESCRIPTION OF EMBODIMENTS

Hereinafter, an exemplary embodiment of the present invention will be described with reference to the drawings.

### Example Embodiment 1

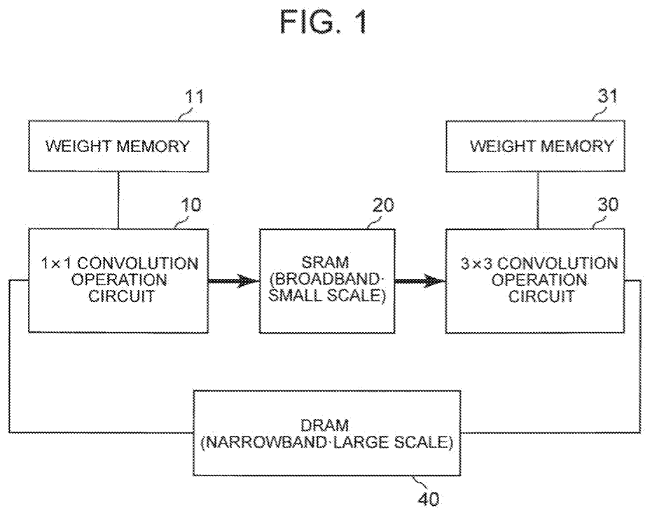

FIG. 1 is a block diagram showing an exemplary configuration of a neural network circuit according to the first example embodiment.

The neural network circuit shown in FIG. 1 includes a 1×1 convolution operation circuit 10, a weight memory 11, a 3×3 convolution operation circuit 30, a weight memory 31, a DRAM 40, and an SRAM (Static Random Access Memory) 20.

The weight memory 11 stores a weight coefficient for 1×1 convolution operation. The weight memory 31 stores a weight coefficient for 3×3 convolution operation.

The neural network circuit shown in FIG. 1 performs convolution operation in a spatial direction and convolution operation in a channel direction separately. Specifically, the 1×1 convolution operation circuit 10 reads data to be computed from the DRAM 40 and performs the pointwise convolution (convolution in the channel direction using a 1×1 filter) in the depthwise separable convolution using the weight coefficient read from the weight memory 11. The 3×3 convolution operation circuit 30 reads data to be computed from the SRAM 20 and performs the depthwise convolution (convolution in the spatial direction using a 3×3 filter) in the depthwise separable convolution using the weight coefficient read from the weight memory 31.

In this exemplary embodiment, the size of the filter used in the depthwise convolution is 3×3, i.e., 3×3 convolution operation is performed in the depthwise convolution, but it is not essential that the size of the filter be 3, and the size of the filter may be N×N (N: natural number of 2 or more).

The DRAM 40 stores a computation result of the 3×3 convolution operation circuit 30. The 1×1 convolution operation circuit 10 reads data to be computed from the DRAM 40. The SRAM 20 stores a computation result of the 1×1 convolution operation circuit 10. The 3×3 convolution operation circuit 30 reads data to be computed from the SRAM 20.

The circuit configuration as shown in FIG. 1 is adopted for the following reasons.

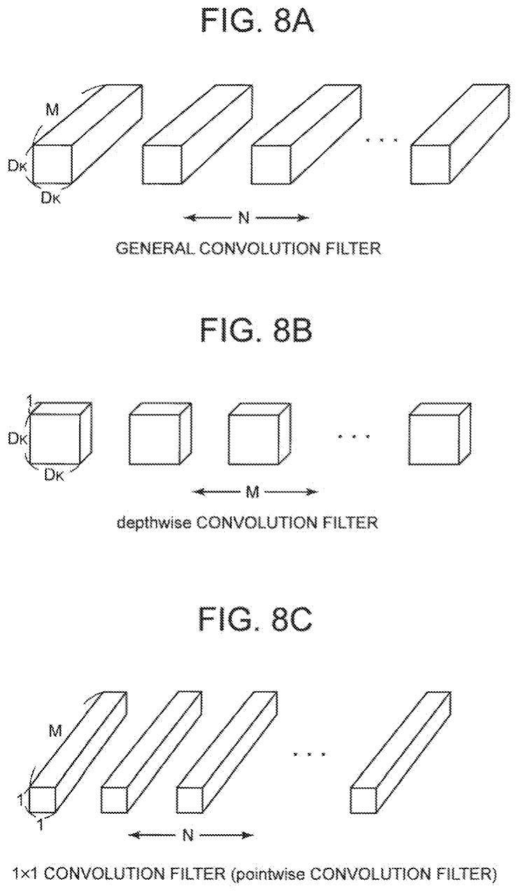

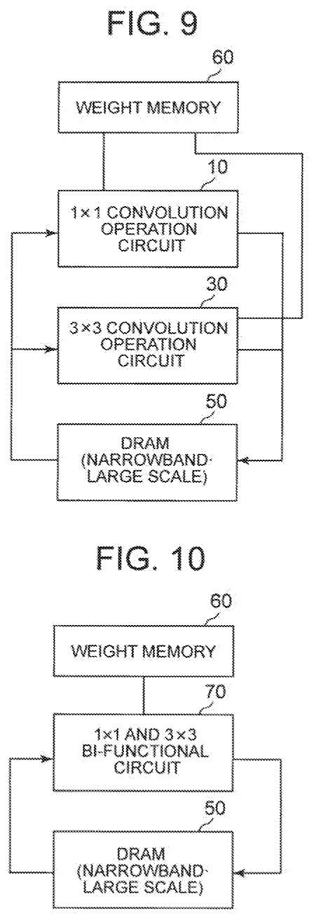

The neural network circuit shown in FIG. 1 corresponds to an example where a 3×3 filter is used in the depthwise convolution, referring to the depthwise separable convolution shown in FIGS. 8B and 8C. In other words, D_{K}=3.

The calculation amount of the 3×3 convolution operation circuit 30 are H·W·M·3² (assume the equation is (4)). The calculation amount of the 1×1 convolution operation circuit 10 is H·W·M·N (assume the equation is (5)). As mentioned above, in general, the value of the number of output channels N is much larger than D_{K}. In other words, N>>D_{K} (in this example, 3). As an example, any value between 64 and 1024 is used as N. The same value is used for the number of input channels M.

Comparing equation (4) with equation (5), it can be seen that the calculation amount of the 1×1 convolution operation circuit 10 is several times larger than that of the 3×3 convolution operation circuit 30. On the other hand, the difference in the size of the input to the 1×1 convolution operation circuit 10 and the 3×3 convolution operation circuit 30 is M1/M3, and in general, since M1=M3 or M1*2=M3 is often used, the difference is at most twice as large. In other words, the 3×3 convolution operation circuit 30, which is several times smaller in the calculation amount, is more likely to become a memory bottleneck than the 1×1 convolution operation circuit 10.

Therefore, as mentioned above, if the time required for the 3×3 convolution operation circuit 30 to read the computation result of the 1×1 convolution operation circuit 10 from the memory element is long, the overall computation speed of the neural network circuit will decrease.

Accordingly, as shown in FIG. 1, the SRAM 20 is installed between the 1×1 convolution operation circuit 10 and the 3×3 convolution operation circuit 30 so that the computation results of the 1×1 convolution operation circuit 10 are stored in the SRAM 20.

The data read speed from a SRAM element (chip) is faster than the data read speed from a DRAM element. Therefore, the overall computation speed of the neural network circuit is improved by the arrangement of the SRAM 20 as shown in FIG. 1.

Due to the fact that the integration of the SRAM element is lower than that of the DRAM element, capacity unit price of the SRAM element is more expensive than capacity unit price of the DRAM element.

However, in the configuration shown in FIG. 1, all the computation results of the 1×1 convolution operation circuit 10 do not have to be stored in the SRAM 20. That is the reason that the 3×3 convolution operation circuit 30 can start the convolution operation once the computation results of the convolution operation for three rows by the 1×1 convolution operation circuit 10 are stored in the SRAM 20. Therefore, in this exemplary embodiment, it is not required to install a large-capacity SRAM 20. As a result, even if the SRAM 20 is used, the cost increase of the neural network circuit can be suppressed.

The calculation amount of the 3×3 convolution by the 3×3 convolution operation circuit 30 is less than the calculation amount of the 1×1 convolution by the 1×1 convolution operation circuit 10. Accordingly, as shown in FIG. 1, even if the circuit is configured so that the computation result of the 3×3 convolution is supplied to the 1×1 convolution operation circuit 10 through the DRAM 40, the impact of such configuration on the overall computation speed of the neural network circuit is relatively small.

As mentioned above, the calculation amount of the 1×1 convolution operation circuit 10 is larger than the calculation amount of the 3×3 convolution operation circuit 30. For example, where N=1024, the calculation amount of the 1×1 convolution operation circuit 10 is (1024/9)=about 114 (times) the calculation amount of the 3×3 convolution operation circuit 30.

It is preferable that the ratio of the number of calculators in the 1×1 convolution operation circuit 10 to the number of calculators in the 3×3 convolution operation circuit 30 is set according to the calculation amount. Each calculator performs convolution operation. In the example of N=1024, the number of calculators in the 1×1 convolution operation circuit 10 may be set to about 100 to 130 times the number of calculators in the 3×3 convolution operation circuit 30, for example. The method of setting the number of calculators according to the calculation amount can be effectively used, for example, when there is a restriction on the total number of calculators. One example of a case where the total number of calculators is limited is when the neural network circuit is constructed using an FPGA (Field Programmable Gate Array), as described below.

In addition, the number of input channels M and the number of output channels N are often set to the nth power of 2 (n: natural number), respectively. Then, when each of the number of calculators in each of the 1×1 convolution operation circuit 10 and the 3×3 convolution operation circuit 30 is the nth power of 2, the affinity with various convolutional neural networks will be high.

### Example Embodiment 2

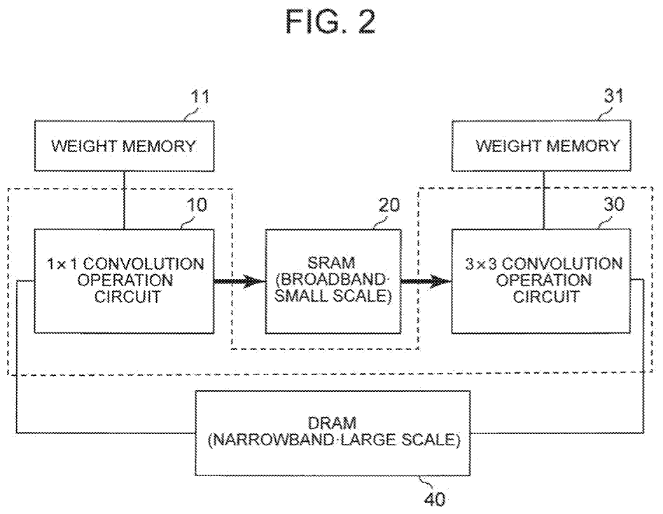

FIG. 2 is a block diagram showing an exemplary configuration of a neural network circuit of the second example embodiment.

In the second example embodiment, the 1×1 convolution operation circuit 10 and the 3×3 convolution operation circuit 30 in the neural network circuit are constructed on the FPGA 101. The functions of the 1×1 convolution operation circuit 10 and the 3×3 convolution operation circuit 30 are the same as those in the first example embodiment.

### Example Embodiment 3

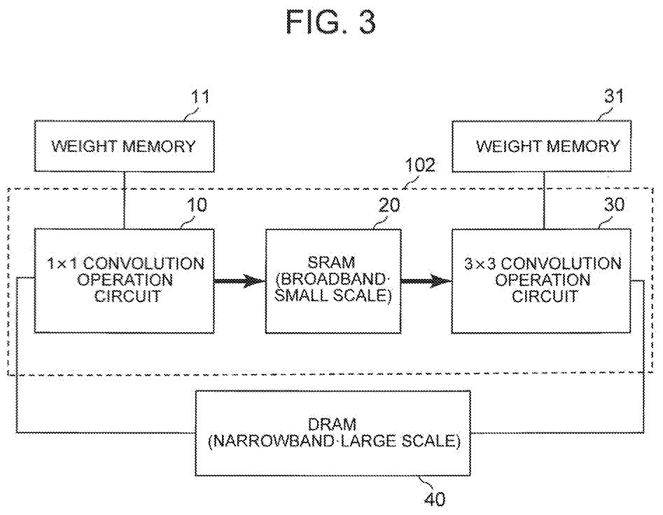

FIG. 3 is a block diagram showing an exemplary configuration of a neural network circuit of the third example embodiment.

In the third example embodiment, in addition to the 1×1 convolution operation circuit 10 and the 3×3 convolution operation circuit 30 in the neural network circuit, the SRAM 20 is also constructed on the FPGA 102. The functions of the 1×1 convolution operation circuit 10, the

SRAM 20, and the 3×3 convolution operation circuit 30 are the same as those in the first example embodiment.

### Example Embodiment 4

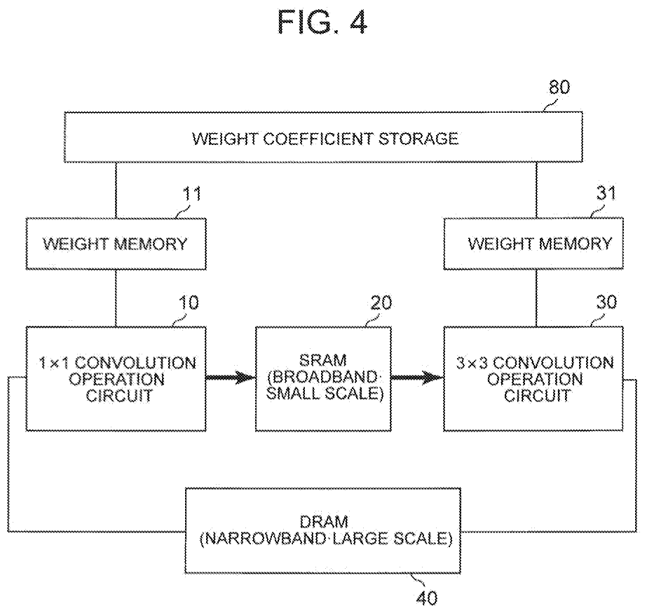

FIG. 4 is a block diagram showing an exemplary configuration of a neural network circuit of the fourth example embodiment 4.

A weight coefficient storage 80 is clearly shown in FIG. 4. In the weight coefficient storage 80, for example, all the weight coefficients that can be used in one convolution layer are set in advance. When the 1×1 convolution operation and the 3×3 convolution operation are alternately performed many times repeatedly, the weight coefficient for the 1×1 convolution operation is transferred from the weight coefficient storage 80 to the weight memory 11 before the 1×1 convolution operation of a certain time is started. The weight coefficient for the 3×3 convolution operation is transferred from the weight coefficient storage unit 80 to the weight memory 31 before the 3×3 convolution operation of a certain time is started.

The functions of the 1×1 convolution operation circuit 10, the weight memory 11, the SRAM 20, the 3×3 convolution operation circuit 30, the weight memory 31, and the DRAM 40 shown in FIG. 4 are the same as in the first to third example embodiments.

The weight memory 11 is provided in correspondence with the 1×1 convolution operation circuit 10. The weight memory 31 is provided in correspondence with the 3×3 convolution operation circuit 30. As mentioned above, once the computation results of the convolution operation for three rows by the 1×1 convolution operation circuit 10 are stored in the SRAM 20, the 3×3 convolution operation circuit 30 can start the convolution operation. Thereafter, the 1×1 convolution operation circuit 10 and the 3×3 convolution operation circuit 30 operate in parallel. The 1×1 convolution operation circuit 10 and 3×3 convolution operation circuit 30 operate in parallel, and this also improves the overall computation speed of the neural network circuit. Moreover, since the weight memory 11 and the weight memory 31 work separately, by constructing the neural network circuit so that the weight coefficient for the 3×3 convolution operation is transferred from the weight coefficient storage unit 80 to the 3×3 convolution operation circuit 30 while the 1×1 convolution operation circuit 10 is performing the convolution operation for the first three rows for example, the overall computation speed of the neural network circuit is further improved.

As explained above, in each of the above exemplary embodiments, in the neural network circuit which divides the convolution operation into the convolution operation in the spatial direction and the convolution operation in the channel direction, and performs the respective convolution operation separately, the computation result of the 1×1 convolution operation circuit 10 is stored in the SRAM 20, and the 3×3 convolution operation circuit 30 is configured to obtain the computation results of the 1×1 convolution operation circuit 10 from the SRAM 20, the overall computation speed of the neural network circuit is improved while the increase in the price of the neural network circuit is suppressed.

In each of the above exemplary embodiments, MobileNets as described in the non-patent literature 1 is used as an example of the depthwise separable convolution, but the neural network circuit of each exemplary embodiments is applicable to the depthwise separable convolution other than MobileNets. For example, the processing of the part corresponding to the 3×3 convolution operation circuit 30 is not the depthwise convolution, but may be GroupedConvolution, which is a general system of the depthwise convolution. Grouped Convolution is to divide the input channel to Convolution into G groups and perform convolution in group units. In other words, when the number of input channels is M and the number of output channels is N, G 3×3 convolutions are performed in parallel, where the number of input channels is M/G and the number of output channels is N/G. The depthwise convolution corresponds to the case where M=N=G in the GroupedConvolution.

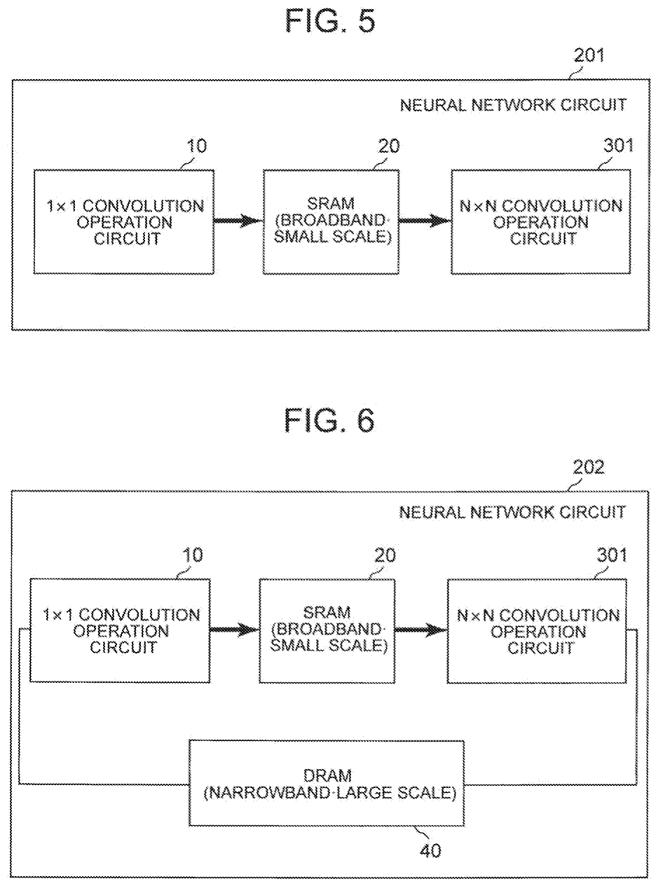

FIG. 5 is a block diagram showing a main part of the neural network circuit. The neural network circuit 201 shown in FIG. 5 comprises a 1×1 convolution operation circuit 10 that performs convolution in the channel direction, an SRAM 20 in which a computation result of the 1×1 convolution operation circuit 10 is stored, and an N×N convolution operation circuit 301 (in the exemplary embodiments, realized by the 3×3 convolution operation circuit 30 shown in FIG. 1, etc. , for example) that performs convolution in the spatial direction for the computation result stored in the SRAM 20.

FIG. 6 is a block diagram showing a main part of another neural network circuit. The neural network circuit 202 shown in FIG. 6 further comprises a DRAM 40 in which a computation result of the N×N convolution operation circuit 301 is stored, and the 1×1 convolution operation circuit 10 performs convolution in the channel direction for the computation result stored in the DRAM 40.

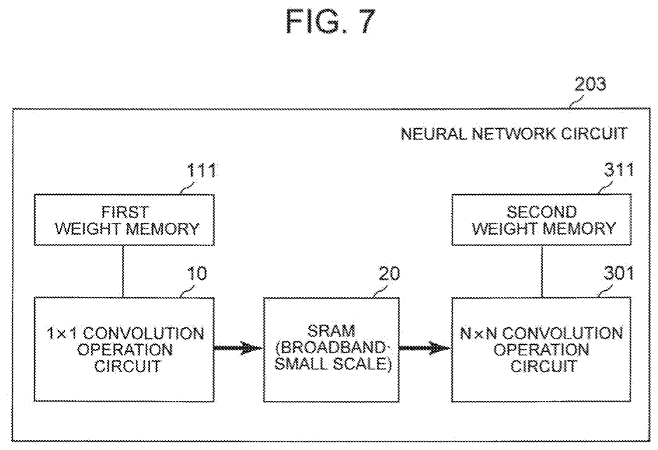

FIG. 7 is a block diagram showing a main part of still another neural network circuit. The neural network circuit 203 shown in FIG. 7 further comprises a first weight memory 111 that stores a weight coefficient used by the 1×1 convolution operation circuit 10 (in the exemplary embodiments, realized by the weight memory 11 as shown in FIG. 1, etc. , for example), and a second weight memory 311 that stores a weight coefficient used by the N×N convolution operation circuit 301 (in the exemplary embodiments, realized by the weight memory 31 as shown in FIG. 1, etc. , for example), and the 1×1 convolution operation circuit 10 and the N×N convolution operation circuit 301 perform convolution operation in parallel.

Although the invention of the present application has been described above with reference to example embodiments, the present invention is not limited to the above example embodiments. Various changes can be made to the configuration and details of the present invention that can be understood by those skilled in the art within the scope of the present invention.

### REFERENCE SIGNS LIST

10 1×1 convolution operation circuit

11 Weight memory

20 SRAM

30 3×3 convolution operation circuit

31 Weight memory

40 DRAM

80 Weight coefficient storage unit

101, 102 FPGA

111 First weight memory

301 N×N convolution operation circuit

311 Second weight memory

201, 202, 203 Neural network circuit

What is claimed is:

1. A neural network circuit that divides convolution operation into convolution operation in a spatial direction and convolution operation in a channel direction, and performs the respective convolution operation separately, comprising:
a 1×1 convolution operation circuit that performs convolution in the channel direction;
an SRAM in which a computation result of the 1×1 convolution operation circuit is stored; and
an N×N convolution operation circuit that performs convolution in the spatial direction for the computation result stored in the SRAM.

2. The neural network circuit according to claim 1, further comprising
a DRAM in which a computation result of the N×N convolution operation circuit is stored,
wherein the 1×1 convolution operation circuit performs the convolution in the channel direction for the computation result stored in the DRAM.

3. The neural network circuit according to claim 1,
wherein N is 3.

4. The neural network circuit according to claim 1,
wherein the number of calculators in the 1×1 convolution operation circuit and the number of calculators in the N×N convolution operation circuit are set according to a computation cost.

5. The neural network circuit according to claim 4,
wherein the number of the calculators in the 1×1 convolution operation circuit is greater than the number of the calculators in the N×N convolution operation circuit.

6. The neural network circuit according to claim 1,
wherein the number of the calculators in the 1×1 convolution operation circuit and the number of the calculators in the N×N convolution operation circuit are n powers of 2, respectively.

7. The neural network circuit according to claim 1, further comprising:
a first weight memory that stores a weight coefficient used by the 1×1 convolution operation circuit; and
a second weight memory that stores a weight coefficient used by the N×N convolution operation circuit,
wherein the 1×1 convolution operation circuit and the N×N convolution operation circuit perform convolution operation in parallel.

8. The neural network circuit according to claim 1,
wherein at least the 1×1 convolution operation circuit and the N×N convolution operation circuit are constructed on an FPGA.

9. The neural network circuit according to claim 8,
wherein the SRAM is also constructed on the FPGA.

10. The neural network circuit according to claim 2,
wherein N is 3.

11. The neural network circuit according to claim 2,
wherein the number of calculators in the 1×1 convolution operation circuit and the number of calculators in the N×N convolution operation circuit are set according to a computation cost.

12. The neural network circuit according to claim 3,
wherein the number of calculators in the 1×1 convolution operation circuit and the number of calculators in the N×N convolution operation circuit are set according to a computation cost.

13. The neural network circuit according to claim 2,
wherein the number of the calculators in the 1×1 convolution operation circuit and the number of the calculators in the N×N convolution operation circuit are n powers of 2, respectively.

14. The neural network circuit according to claim 3,
wherein the number of the calculators in the 1×1 convolution operation circuit and the number of the calculators in the N×N convolution operation circuit are n powers of 2, respectively.

15. The neural network circuit according to claim 4,
wherein the number of the calculators in the 1×1 convolution operation circuit and the number of the calculators in the N×N convolution operation circuit are n powers of 2, respectively.

16. The neural network circuit according to claim 5,
wherein the number of the calculators in the 1×1 convolution operation circuit and the number of the calculators in the N×N convolution operation circuit are n powers of 2, respectively.

17. The neural network circuit according to claim 2, further comprising:
a first weight memory that stores a weight coefficient used by the 1×1 convolution operation circuit; and
a second weight memory that stores a weight coefficient used by the N×N convolution operation circuit,
wherein the 1×1 convolution operation circuit and the N×N convolution operation circuit perform convolution operation in parallel.

18. The neural network circuit according to claim 3, further comprising:
a first weight memory that stores a weight coefficient used by the 1×1 convolution operation circuit; and
a second weight memory that stores a weight coefficient used by the N×N convolution operation circuit,
wherein the 1×1 convolution operation circuit and the N×N convolution operation circuit perform convolution operation in parallel.

19. The neural network circuit according to claim 4, further comprising:
a first weight memory that stores a weight coefficient used by the 1×1 convolution operation circuit; and
a second weight memory that stores a weight coefficient used by the N×N convolution operation circuit,
wherein the 1×1 convolution operation circuit and the N×N convolution operation circuit perform convolution operation in parallel.

20. The neural network circuit according to claim 5, further comprising:
a first weight memory that stores a weight coefficient used by the 1×1 convolution operation circuit; and
a second weight memory that stores a weight coefficient used by the N×N convolution operation circuit,
wherein the 1×1 convolution operation circuit and the N×N convolution operation circuit perform convolution operation in parallel.
